(19) United States
(12) Patent Application Publication
(10) Pub. No.: US 2012/0043467 A1
(43) Pub. Date: Feb. 23, 2012

(54) Single plane compton camera

(76) Inventors: Andrey Gueorguiev, Oak Ridge, TN (US); Juergen Stein, Oak Ridge, TN (US); Jeffrey R. Preston, Knoxville, TN (US); Leslie D. Hoy, Knoxville, TN (US); Claus-Michael Herbach, Dresden (DE)

(21) Appl. No.: 12/806,621

(22) Filed: Aug. 17, 2010

(51) Int. Cl. G01T 1/20; G01T 1/26

(52) U.S. Cl. 250/363.01; 250/371

(57) ABSTRACT

A single plane Compton telescope uses a coplanar array of detectors to determine the direction of a radiation source. Detector materials and dimensions may have comparable Compton scattering and photoelectric absorption probabilities, so scattered photons have a high probability of escape from the detector in which the initial interaction occurs, while being absorbed in adjacent detectors. Energy information from coincident interactions between two detectors defines a bearing plane that contains the radiation source; by comparing these interactions in two non-parallel directions, the source is localized to a line representing the intersection of two bearing planes. Energies may be summed to determine the initial photon energy. The array may be of a single detector type or an arrangement of different detector types. The array may be a stationary, planar configuration of at least three detectors, or a linear array of at least two detectors that is rotatable within a selected plane.

### BACKGROUND OF THE INVENTION

1. Field of the Invention

The invention pertains to apparatus and methods for radiation measurement, and more particularly to apparatus and methods to resolve the position and direction of a distant radiation source.

2. Description of Related Art

In the field of radiation measurement, it is often desirable to determine the location of a radiation source; this is particularly true in applications involving safety or security, in which there is a need to quickly locate a radioisotope that is concealed, for example, in a vehicle passing near a screening point. Because many isotopes of interest emit gamma radiation, conventional detectors frequently make use of the phenomenon of Compton scattering and are referred to as Compton cameras or Compton telescopes.

The Compton telescope design originates with the discovery of Compton scattering. Incident radiation is scattered upon interaction with a detector that records the energy of the Compton electron produced. The corresponding photon escapes the first detector and imparts energy in a second detector that records the energy of the scattered photon. The relation between the incident photon energy and the scattered photon energy is dependent on the scattering angle, θ, shown by the Compton formula in Equation (1), where mc² refers to the rest mass of a free electron. The scattering angle is a function of the number density of electrons in the detector material and the energy of the incident photon.

$${E}^{′} = \frac{E}{1 + ( \frac{E}{{mc}^{2}} ) ( 1 - cos θ )} \qquad ( 1 )$$

Compton telescope designs make use of this fundamental relation to determine remote source position. Existing design concepts use at least two parallel planes of detectors that record interaction energies from incident and single- or multiple-scattered photons in each plane. Geometric configurations of arrays and corresponding detector material selections vary depending on the energy of the incident radiation, intended collection efficiency, and reconstruction method applied.

Two-plane designs typically include a scattering plane comprising low-Z materials and an absorption plane comprising high-Z materials. The low-Z material has a higher probability of Compton scattering for incident energies between 100 keV and 3 MeV, while the high-Z material has a higher probability of photoelectric absorption of the scattered photons for the same energy range. The events are time discriminated to minimize effects of chance events from interactions with naturally occurring background radiation. Energy data from both interactions are summed to determine the initial photon energy. The two planes are typically separated by a distance that ranges from 30 cm to perhaps 1 m; as a consequence, many conventional Compton cameras are very large devices and are cumbersome to use in the field. A further discussion of the Compton camera is given by Basko et al., “Analytical Reconstruction Formula for One-Dimensional Compton Camera,” IEEE Trans. Nucl. Sci. 44 (3):1342-46 (1977).

Designs consisting of more than two planes typically are created with silicon detectors that provide separate readouts for each plane and rely on multiple Compton scattering events to determine the initial photon energy. Each interaction deposits a portion of the initial photon energy until a scattered photon in fully absorbed in one of the detector layers. Energy absorbed in each interaction is time discriminated and summed to determine the initial photon energy.

Once the incident photon energy is known, the incident Compton angle may be determined using the Compton formula. This relation does not include any means to determine the azimuthal angle, but rather yields a probability cone where the radiation source may be located. As the number of Compton events increases, the cones are superimposed on either a 2-D or 3-D plane, depending on the reconstruction method applied and the configuration of the array. The resulting superimposed image is intensity contrasted to determine the location of the radiation source relative to the detector array.

Uncertainty in Compton angle determination restricts the back projected cone into having a minimum achievable thickness that is a function of the detector materials, sizes and array configuration. One method for reducing this uncertainty is to design the front plane to have a coded aperture that is a combination of heavy absorbing shielding material, such as lead or tungsten, and detectors, as taught, for example, by Gottesman in U.S. Pat. No. 7541,592, and by Lanza in U.S. Pat. No. 5,930,314. A further technical discussion of the coded aperture mask is given by Forot et al., “Compton Telescope with Coded Aperture Mask: Imaging with the INTEGRAL/IBIS Compton Mode,” Astrophys. Jour. 668:1259-65 (2007). A distant source impingent on the coded aperture plane has nearly all photons incident upon the shielding material absorbed, while photons incident upon detectors are Compton scattered to the back plane. The Compton scattered photons cast a shadow on the second plane of detectors that is unique to the position of the source relative to the detector array. The coded aperture design geometrically reduces the uncertainty of the Compton angle, but at the expense of detection efficiency.

What is needed, therefore, is a detector that combines high intrinsic efficiency for Compton scattering (i.e., a low number of counts are required for determining the source direction) with a simple and accurate means of determining the direction and position of the radiation source of interest.

### OBJECTS AND ADVANTAGES

Objects of the present invention include the following: providing a Compton camera having improved detection efficiency; providing a Compton camera having the ability to locate the position of a radiation source using relatively simple computational methods; providing a Compton camera having a relatively compact layout; providing a Compton camera having relatively few detection elements; providing a Compton camera that is easily scalable to create the most compact device for a given absolute efficiency; providing a method for locating a radiation source using a Compton camera having a relatively compact overall size and using relatively simple computational methods; and, providing a method for locating a radiation source using a Compton camera having a single detection plane. These and other objects and advantages of the invention will become apparent from consideration of the following specification, read in conjunction with the drawings.

### SUMMARY OF THE INVENTION

According to one aspect of the invention, a Compton camera for locating a radiation source comprises:

at least three energy-discriminating radiation detectors in a substantially planar array, the detectors being sufficiently close together that incident radiation scattered from one of the detectors has a finite probability of capture by another of the detectors;

a detection circuit comprising at least a pulse height analyzer for each of the detectors;

a means of comparing the average energy detected coincidentally by each of a first pair of the detectors, to define a first source plane containing the radiation source;

a means of comparing the average energy detected coincidentally by each of a second pair of the detectors, not co-linear with the first pair of detectors, to define a second source plane containing the radiation source, the radiation source being thereby localized to the line of intersection of the first and second source planes.

According to another aspect of the invention, a method for locating a radiation source comprises the steps of:

configuring a Compton camera with at least three energy discriminating detectors in a substantially planar array, the detectors being sufficiently close together that incident radiation scattered from one of the detectors has a finite probability of capture by another of the detectors;

comparing the average energy detected coincidentally by each of a first pair of the detectors and calculating the bearing angle defining a first source plane containing the radiation source;

comparing the energy detected coincidentally by each of a second pair of the detectors, not co-linear with the first pair of detectors, and calculating the bearing angle defining a second source plane containing the radiation source; and,

determining the line of intersection of the first and second source planes.

According to another aspect of the invention, a method for locating a radiation source comprises the steps of:

configuring a Compton camera with at least two energy discriminating detectors in a substantially linear array, the detectors being sufficiently close together that incident radiation scattered from one of the detectors has a finite probability of capture by another of the detectors;

comparing the average energy detected coincidentally by each of at least a pair of the detectors while holding the linear array in a first position and calculating the bearing angle defining a first source plane containing the radiation source;

rotating the linear array to a second position, coplanar with the first position;

comparing the energy detected coincidentally by each of at least a pair of the detectors while holding the linear array in the second position and calculating the bearing angle defining a second source plane containing the radiation source; and,

determining the line of intersection of the first and second source planes.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic diagram of one embodiment of the present invention. FIG. 1A shows a side-by-side configuration of two detectors, and FIG. 1B shows the L-R energy difference versus angular bearing to the source for one source energy.

FIG. 2 is a schematic diagram of the data obtained from two detectors in a side-by-side arrangement. FIG. 2A illustrates energy spectra for a source oriented at a bearing of 90°; FIG. 2B illustrates the case of a source oriented at a bearing of 45°.

FIG. 3 is a schematic diagram showing how the direction of the source is found by the intersection of two planes determined from comparing LEFT-RIGHT detectors and UP-DOWN detectors respectively.

FIG. 4 illustrates schematically a square array of detecting elements according to one example of the invention.

FIG. 5 illustrates schematically a triangular array of detecting elements according to one example of the invention.

FIG. 6 illustrates schematically a hexagonal array of detecting elements according to one example of the invention.

FIG. 7 illustrates schematically how the direction of the source is found by the intersection of three planes determined from comparing adjoining detectors in three directions in a triangular or hexagonal array.

### DETAILED DESCRIPTION OF THE INVENTION

The inventive single plane Compton camera uses a coplanar array of detectors to determine the direction of a distant radiation source. Detector materials and dimensions may be configured to have comparable Compton scattering and photoelectric absorption probabilities, such that the scattered photons have a finite, and preferably high probability of escape from the detector in which the initial interaction occurs, while being absorbed in adjacent detectors. Energy information recorded from coincident interactions between two detectors may be summed to determine the initial photon energy. Detectors in the array may be of a single detector type or an arrangement of different detector types.

The detector array may be arranged in a linear, square, triangular, hexagonal, or other layout associated with a geometric configuration depending on detector geometry and intended efficiency for a specific application, where combinations of detectors are compared for coincident events. For a stationary array, the preferred minimum number of detectors in the array is three or four, preferably arranged in two nonparallel directions within the plane. (Three detectors may be arranged to allow pairwise comparisons in three directions oriented at 60° from each other; four detectors may be arranged to allow pairwise comparisons in two directions oriented at 90° from each other, for example.) Each detector combination's coincident event energies may be compared using the mean energy absorbed in each event over some time duration. When the position of the remote source is perpendicular to both axes of the design, the coincident event energy distributions of each adjacent detector combination are nearly equivalent with variance according to Poisson counting statistics, resulting in similar mean event energies.

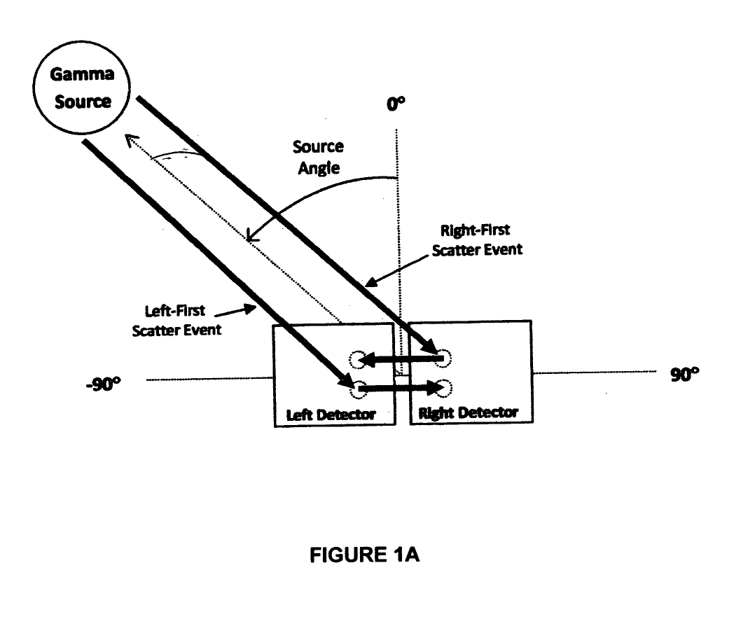

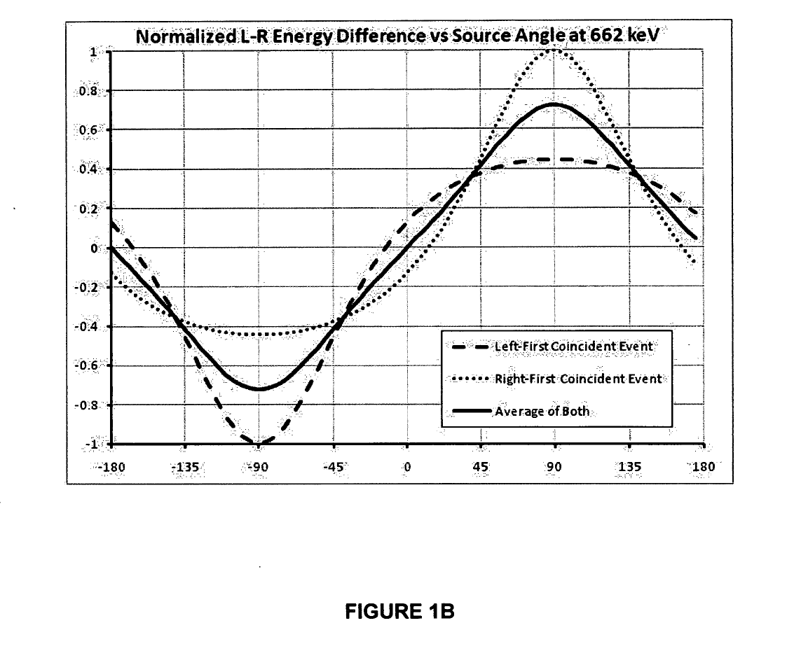

As the angle between the source and the centroid of the array changes in the X-axis, as shown schematically in FIG. 1, the mean event energies deviate from equivalence. The Compton formula implies that the detector in which the Compton scattering event occurs acquires a larger amount of the initial photon energy in the form of the Compton electron that is fully absorbed in that detector, while the detector absorbing the scattered photon acquires a smaller amount of energy from the subsequent Compton scatter or photoelectric absorption event. The mean coincident event energies are larger for the detectors in which the initial events occur, and lower for the detectors in which the subsequent events occur.

Rather than using the conventional conical back projection method to determine the source location, Applicants have discovered that a relation between the mean coincident event energies may be used to determine the source direction in a single dimension rather than a computed Compton angle for each separate event. Coincident event energy distributions may be constrained to include events that are within a specific region of interest or that sum to incident photon energies of interest. The relation for a two-detector combination in the horizontal (X) or in the vertical (Y) plane may be

$$V = \frac{〈 {E}_{1} 〉 - 〈 {E}_{2} 〉}{〈 {E}_{1} + {E}_{2} 〉} \qquad ( 2 )$$

When the relation is applied to a square lattice structure as in the detectors described in Table 1, combinations of detectors in the X- and Y-axes may be evaluated independently in single axis rows that allow the direction vector from the relation to exist in only the X- or Y-directions. A summation of all combinations in both axes results in a unit vector with components in the X- and Y-directions that specify the direction of the source relative to the centroid of the detector plane.

$${V}_{s} = \frac{\sum {V}_{X} + \sum {V}_{Y}}{\vert \sum {V}_{X} + {\sum }_{{V}_{Y}} \vert} \qquad ( 3 )$$

The foregoing discussion applies to the case in which a two-dimensional array of detectors is held in a substantially stationary position for the duration of counting. Those skilled in the art will appreciate that the inventive method may also be carried out using a linear array of detection elements (the minimum number in this case would be two detectors) that is held in a first position for part of the counting process, and then rotated, preferably 90°, for a second time period. As will be shown in the following examples, this method yields results that are physically equivalent to those of a stationary two-dimensional array.

In the following examples, for simplicity, the discussion will emphasize detection of gamma radiation. It will be appreciated, however, that other types of radiation also exhibit the Compton scattering phenomenon, and the inventive apparatus and methods may therefore be useful for those situations as well. Some examples include: electrons, protons, neutrons, and other particles.

### EXAMPLE

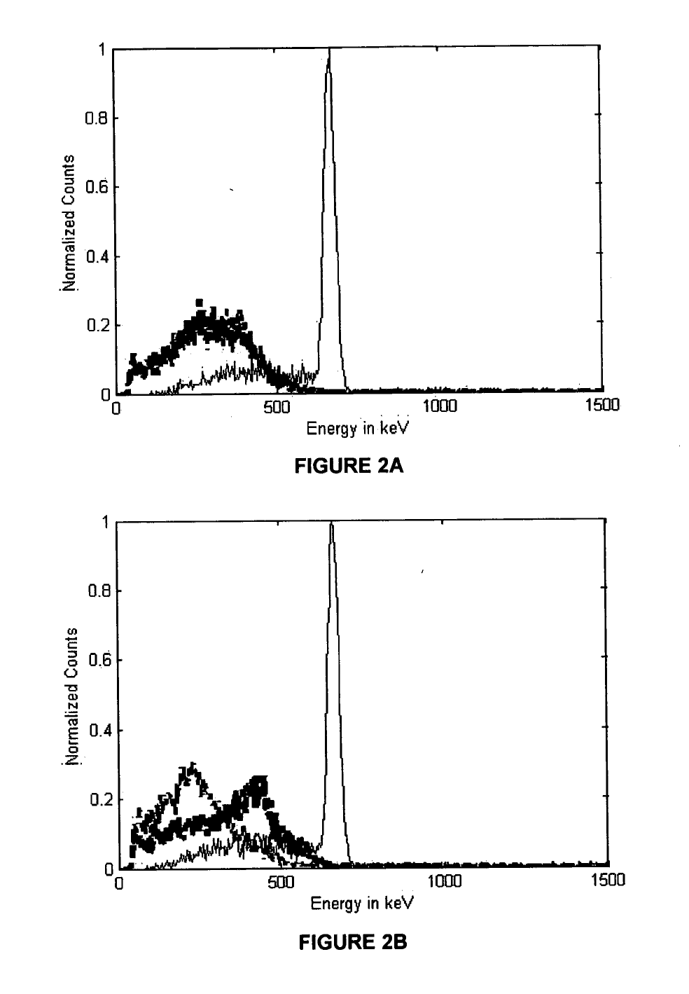

FIG. 1 shows the simplest possible configuration of the inventive single plane Compton camera. In this configuration, two scintillator or semiconductor detectors, left, L and right, R are placed side-by-side in close proximity to each other. The remote source, S, is located at some distance from the detector pair at angles defined by the resultant vector. The overall geometrical setting may be defined as follows: The line through the centroids of detectors L and R forms a first axis defining bearing angles −90° and +90° as shown schematically in FIG. 1A. All points that are equidistant from detectors L and R define a plane normal to the first axis and passing through bearing angle 0°. If a source lies directly in this plane, the data produced by detectors L and R will have substantially comparable statistical distributions. However, if source S is not directly in front of the detector pair but instead lies at some other bearing angle as shown in FIG. 1A, then detectors L and R will, on average, record different statistical energy distributions. This result is a direct consequence of the fact that scattered photons received by detector L (in this example) have been back scattered from detector R, whereas scattered photons received by detector R have been forward scattered from detector L. Thus, scattered photons arriving at L will have lower energy than those arriving at R, and by comparing these energies as shown in FIG. 2, the bearing angle of source S may be determined. FIG. 1B provides estimates for the difference of coincident energies for each detector over a range of angles.

### EXAMPLE

A suitable photon detecting element is NaI(Tl), thallium-activated sodium iodide. This detector consists of a block material with an average Z-value of about 32, which is low enough to allow Compton scattering while high enough to have sufficient photoelectric absorption probabilities for incident energies between 100 keV and 3 MeV. The detector has a density of 3.61 g/cm³ and typically yields an energy resolution of 6% to 8% at 662 keV. A decay time of nearly 250 ns allows for sufficient time discrimination in the order of tens of nanoseconds.

The electronics package included a set of the following for each detector: a photomultiplier tube, high voltage supply, preamplifier, amplifier, ADC for digitalization of analog signal, and FPGA for timing analysis. The FPGA used an interpolative method for determining pulse start time. The method uses two points along the rising edge of the pulse to extrapolate the intersecting point of the line between those two points and the baseline voltage, which is returned by the routine as the starting point of the pulse. An external absolute clock is sampled for the time stamp of the event. The pulse height and time stamp are output to an embedded CPU that collects events for a given period of time before sending a collection of events to a central computer for coincidence analysis.

It will be appreciated that many other scintillating materials are known that are also suitable for implementing the invention. Some suitable materials include BaBrI₂, BaF₂, BGO, CaF₂, CeBr₃, CLAC, CLLB, CLLC, CLYC, CsI, LaBr₃, LaCl₃, LiI, LSO, LYSO, PVT, SrI₂, YAP, YAG, ZnO, ZnS, and other materials as are familiar in the art of scintillation detectors.

It will further be appreciated that the invention may be carried out using various detector types, and that each detector will have an electronics package appropriate to its particular operating characteristics. Thus, the skilled artisan may construct a device for a particular detection environment through routine experimentation and the application of well-known engineering principles. For instance, the electronics may include either a photomultiplier tube, a silicon photodiode, or other photon-electron conversion apparatus, high voltage supply, preamplifier, amplifier, analog to digital converter (ADC) for digitalization of analog signal, and timing circuitry realized by digital or analog methods. Digital methods may include a field programmable gate array (FPGA), digital signal processing (DSP) or other method that estimates the pulse starting time relative to an external clock_{—} Analog methods may include constant fraction discrimination, zero-crossing, or other methods of indicating pulse origination time that is digitized by an ADC, which is also relative to an external clock or time relative to another detector signal. Digitized pulse height and timing data may be passed to a processor that compares the time of each event to a coincidence window. The invention may also employ semiconductor detectors, in which the semiconductor material may be CdTe, CdZnTe, CdSeTe, CdMnTe, GaAs, Ge, HgI₂, PbI₂, Si, TlBr, ZnO, ZnTe, or other suitable materials as are known in the art of semiconductor detectors. Such semiconductor detectors will typically use a detection circuit comprising a high voltage supply, preamplifier, amplifier, analog to digital convertor (ADC), and a field programmable gate array (FPGA) for timing analysis.

### EXAMPLE

An algorithm on the processor selects one detector as providing the start pulse and the second as providing the stop pulse, where the stop pulse time stamps are given a digital constant offset of sufficient length such that any true coincident pulse between the two detectors will always have the start pulse occur first. Events from two detectors are combined into a single array, which contains the time stamps, pulse heights, and detector identification. The array is row sorted according by increasing time, preserving detector identification and pulse height information as the sorting method progresses. The first event from the start detector is selected as the start time, and then next event in the array that occurs in the stop detector is chosen as the stop time, unless multiple events in the start detector occur before an event in the stop detector, in which case the most recent event in the start detector replaces the first event. The time difference between the start and stop events is compared to a time coincidence window, where time differences that are shorter than the window are deemed coincident. Coincident events are passed to a separate array that contains the pulse heights from each detector. Those skilled in the art will appreciate the creation of pulse height spectra of events, where each detector has an individual spectrum representing only those events coincident with the adjacent detector, which is designated as coincident spectra. A separate spectrum of the summation of the paired events is designated as the sum spectrum, which is a reconstruction of the initial incident photon energy. The coincident spectra were analyzed for average energy according to Equation 2.

Two of these devices were placed side-by-side, as shown schematically in FIG. 1A. A source S, consisting of 10 μCi of Cs-137, was first placed at a bearing angle of about 0° and the results of counting for 10 minutes are shown in FIG. 2A. The average energy measured by detector L was 292.7 keV and that measured by detector R was 299.9 keV, a difference of less than 3%. When the source was moved to a bearing angle of +45°, detector L received an average of 339.5 keV, whereas detector R received an average of 247.0 keV, a difference of more than 27%.

### EXAMPLE

Using the primary method described, an additional analysis of data of the preceding example may also be performed to further enhance results for situations with large numbers of coincident counts, but is not required for basic operation. The sum spectrum of events between the two detectors contains events that sum to the incident gamma energy, but also contain events within a continuum below that energy, which correspond to chance coincidence, partial absorptions, or double-Compton scatter events. The sum spectrum was evaluated to select only those paired events whose energies sum to the incident photon energy range, which was 662 keV for Cs-137. Those skilled in the art will understand the selection of a region of interest (ROI) about a photopeak in spectroscopy applications using a peak search function, which was used here to define energy boundaries that were compared to the summation of the coincident energies. Paired events that sum to an energy within this range were added to a separate coincident energy spectrum for both detectors. The energy discriminated coincident spectra remove the effects of chance coincidence, partial absorptions, or double-Compton scatter events, and are symmetric about ½ of the incident gamma energy, which is equivalent to the point corresponding to the mean energy received in a detector for a source angle of 0°. The skewness of the energy discriminated coincident spectra observed in both detectors is of similar magnitude, but has opposite signs, reflecting the symmetry in the coincident event spectrum.

### EXAMPLE

Using the primary method described, a Cs-137 source was moved to a bearing angle of +45°, detector L received an average of 339.5 keV with a skewness of 1.5, and detector R received 247.0 keV with a skewness of 3.3. The peak selection method shows for the same configuration that detector L received an average of 397.4 keV with a skewness of −0.4, and detector R received 262.0 keV with a skewness of 0.4. The difference between magnitudes of the average energy received increases using the peak selection method, which allows for higher angular resolution.

Sources with multiple peaks, e.g. Co-60, can have the directionality formula performed for each peak separately. When the Co-60 source was moved to a bearing angle of +45°, detector L received an average of 523.7 keV, and detector R received 458.2 keV, using the entire energy range. Selecting events from the 1173 keV gamma in Co-60, detector L has a mean of 641.6 keV and skewness −0.3, and the right detector has a mean of 500.1 keV and skewness 0.3. Events from the 1332 keV gamma in Co-60, detector L has a mean of 710.2 keV and skewness −0.3, and the right detector has a mean of 584.6 keV and skewness 0.3. Thus multiple gammas from a source have the same skewness.

For multiple gammas present in the sum spectrum resulting from different sources at different locations, the sorting function permits the directions toward each source to be discerned independently, allowing for simultaneous tracking of multiple sources in the same field of view.

Multiple sources of the same type at different locations equate to the same summed coincident spectrum; however, the coincident events recorded in each individual detector will have multimodal distributions when using the peak selection method. A deconvolution of the distributions may allow tracking of multiple sources of the same type within the field of view.

### EXAMPLE

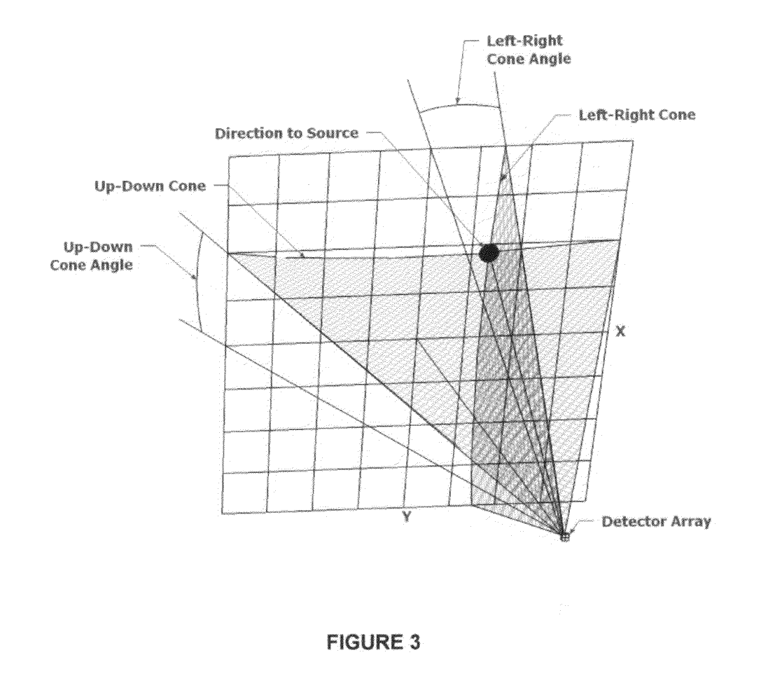

It will be appreciated that for the simplest case of two detector elements, determining the bearing angle to the source only locates the position of a “source plane” on which source S lies, i.e., all points on that plane will satisfy the calculated bearing angle determined from the measured energy difference. By collecting data from a comparable detector pair that define a second axis, coplanar to the first axis and preferably orthogonal to it, a second “source plane” may be determined. The actual position of the source S will now be localized to the line representing the intersection of the two source planes, as shown schematically in FIG. 3.

The detector pair described in the preceding example was placed in a first position and counting was done for 10 minutes. Then the pair was rotated 90° about an axis normal to the line defined by their centroids so that the LEFT and RIGHT detectors became the UP and DOWN detectors, and counting was repeated. The position of source S was thereby localized to a vector representing the intersection of the two planes determined in the two counting processes.

It will be understood that a linear array of more than two detectors may also be used, for added efficiency. In this case, the entire linear array will be rotated through a selected angle to a second position coplanar with but not parallel to the first position.

Those skilled in the art will appreciate that the array size will be chosen according to the absolute efficiency needed for a particular application, absolute efficiency being the ratio of photons emitted from the source to those impingent upon the face of the array. A second efficiency may be described as the intrinsic Compton-absorption efficiency, which is the ratio of the number of paired scattering and absorption events to the total number of photons impingent upon the array surface. The intrinsic Compton-absorption efficiency aids in determining the detector material and array size necessary for a specific apparatus. Larger arrays will increase the absolute efficiency but not necessarily the intrinsic Compton-absorption efficiency.

### EXAMPLE

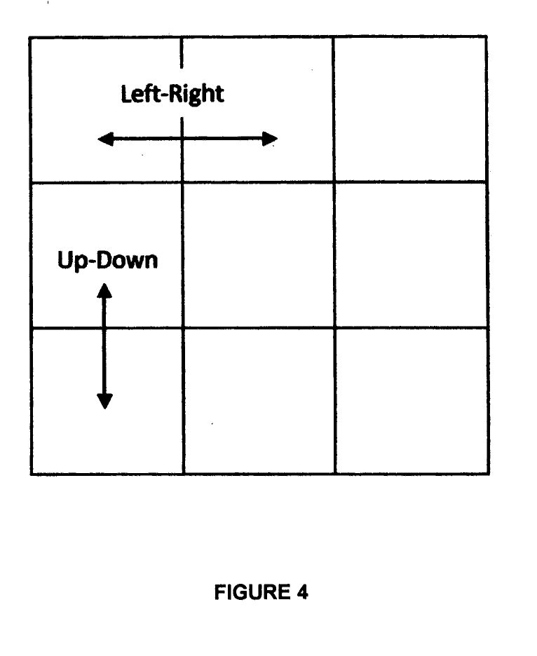

Although the movable two-element detector array described in the preceding example provides the minimal number of detectors needed to carry out the invention, it will be appreciated that the directional accuracy will be limited to some degree by the accuracy associated with rotating the detector pair with the chosen plane. Thus, a planar (2D) array of detectors, while requiring a comparatively larger number of detector elements and their corresponding electronics, may be held in a stationary position, and by comparing the energies received by each detector element in pairwise fashion in the two orthogonal directions within the planar array, the direction of source S may be determined with high accuracy. The array may be configured as a square 2×2, 4×4, or 6×6 element matrix, for example, or any other desired number of elements, as shown generally in FIG. 4. It will be further appreciated that a larger planar array will be inherently more efficient because in a smaller detector, some scattered photons will escape from the periphery without being captured by the second detector.

The relation between the mean coincident event energies may be used to obtain the means that determine the direction of the source. FIG. 2A shows a case where the source is directly in front of the centroid of the detector array. The equivalence of the means shows that the direction is 90° to the detector plane. FIG. 2B shows the case for a source located 45° to the detector plane. The unequal means show the difference between the energies absorbed in the first and second detectors, which indicates that the source is at a 45° angle to the detector plane.

### EXAMPLE

The following TABLE 1 provides estimates of the performance of the inventive single plane Compton camera using NaI(Tl) and CaF₂ detectors, and performance of a conventional dual plane detector with comparable dimensions. It can be seen that the inventive single plane design shows a significant improvement over the dual plane design over the entire energy range.

| | | Intrinsic Efficiency (%) | | | |
|---|---|---|---|---|---|
| | | | | Dual Plane | |
| | | | | Compton Camera | |
| | | Single Plane | Single Plane | 3 × 3 × 1 CaF₂ | |
| | | Compton Camera | Compton Camera | and 3 × 3 × 3 | Performance Gain |
| | | 2 × 2 × 3 NaI(TI) | 2 × 2 × 4 CaF₂ | NaI(TI) | SPCC To DPCC |
| Energy | | 6 × 6 Array | 6 × 6 Array | in 4 × 4 array | (same detection |
| (keV) | Isotope | (30 cm²) | (30 cm²) | (30 cm²) | area and volume) [%] |
| 185 | U-235 | 1.0 | 18.0 | 7.6 | 137 |
| 411 | Pu-239 | 13.0 | 18.0 | 10.4 | 73 |
| 662 | Cs-137 | 17.0 | 14.0 | 9.5 | 47 |
| 766 | U-238 | 17.0 | 13.0 | 7.9 | 65 |
| 1001 | U-238 | 16.0 | 12.0 | 6.6 | 82 |
| 1173 | Co-60 | 15.0 | 11.0 | 4.6 | 139 |
| 1332 | Co-60 | 14.0 | 10.0 | 3.2 | 212 |

The detector arrays in the preceding example were substantially square in plan view and were arranged in a substantially square array. This has the advantage that the two calculated “source planes” are perpendicular to each other and their line of intersection can therefore be accurately located. However, for some applications it may be desired to use other layouts for the detector array.

### EXAMPLE

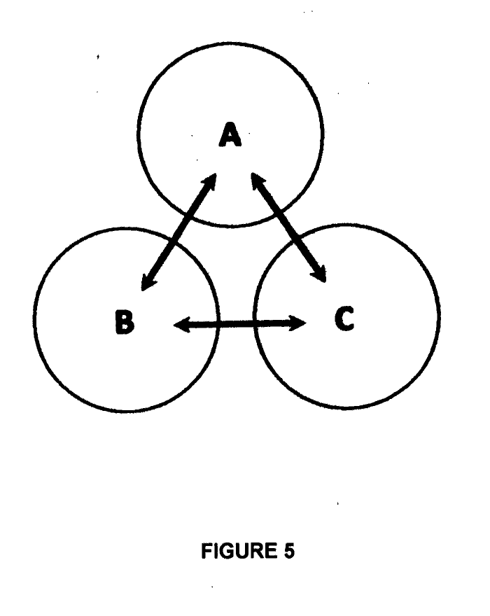

A triangular pitch of detectors will provide three source planes. FIG. 5 shows the basic structure of this array configuration, where each detector in the array will be compared for coincidence, which will result in 3 coincident spectra and 3 source planes. It will be appreciated that an additional source plane will reduce uncertainty in the source position. The source vector is defined as the intersection of the three planes.

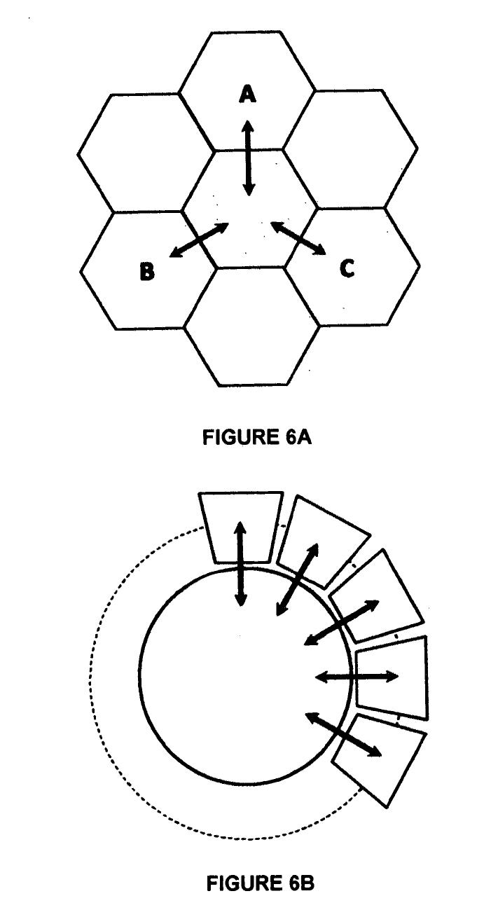

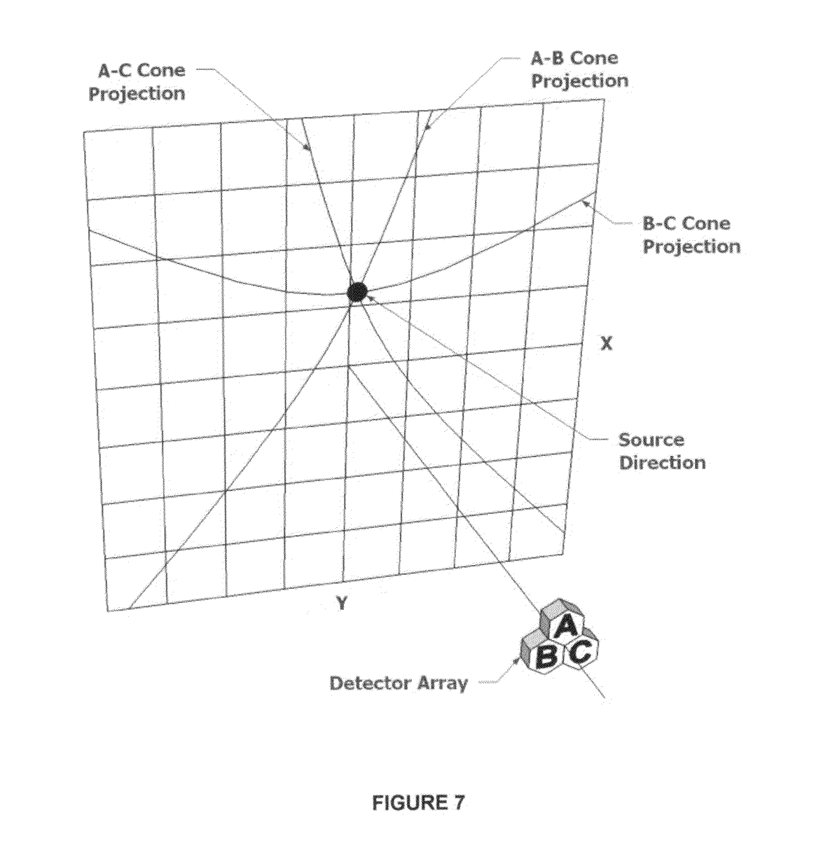

The triangular pitch design may be expanded to create an array of homogeneous detectors, shown in FIG. 6A. The hexagonal appearance is the result of the repeated triangular design, and may be further repeated for larger arrays as is necessary to provide some intended detection efficiency. Repeated designs of the triangular pitch also have 3 source planes, but will have a larger number of coincident spectra that may be evaluated similarly according to collinear designations. Array density is maximized for close packed equilateral designs, but may be modified according to some intended detection efficiency.

Although in many cases, a homogeneous array is contemplated, in which all of the individual detectors are substantially identical to one another, a heterogeneous array may also be designed, in which individual detectors may have different designs. A triangular pitch design, implemented with a heterogeneous array of detectors, is shown in FIG. 6B, where individual detector materials are chosen to maximize absorption or scattering efficiencies depending on the intended design geometry and cost guidelines. Detectors may be of differing size or material depending on said guidelines and still apply the same principles set forth in this invention. Possible applications for this include active well neutron interrogation for multiplicity measurements, neutron imaging, neutron diffraction analysis, etc.

### EXAMPLE

It will be appreciated that medical imaging using PET, CT, or other methods may benefit from utilizing this invention. Current methods using gross counters may neglect absorption events that deposit energies less than some threshold. Using the creation of sum spectra through coincident events occurring in adjacent detectors may reduce the total number of photons necessary for imaging, which will reduce the radiation dose applied to the patient during the imaging procedure.

Those skilled in the art will appreciate that the invention provides numerous advantages over conventional methods. Some of the advantages include:
1. High intrinsic efficiency for Compton scattering
2. The probability for coupled Compton scattering and photoelectric absorption events between detectors is higher than for separate planes over the entire energy range
3. Field of view is nearly 180° in the X- and Y-directions
4. Low number of counts required to determine the source direction
5. The algorithms used to determine the source direction are simple, eliminating the need for advanced computing capabilities
6. The invention can make use of low cost detectors
7. The invention can make use of a single detector type or a combination of multiple detector types to maximize efficiency
8. It may be easily scaled to any desired size, depending on the desired absolute efficiency
9. The design is inherently simple; the direction and position of the source is obtained by an array placed in a single plane
10. It is less complex than a two-plane detector
11. It is a relatively low cost, physically compact solution, which uses less power and is more portable.

We claim:

1. A Compton camera for locating a radiation source comprising:
at least three energy-discriminating radiation detectors in a substantially planar array, said detectors being sufficiently close together that incident radiation scattered from one of said detectors has a finite probability of capture by another of said detectors;
a detection circuit comprising at least a pulse height analyzer for each of said detectors;
a means of comparing the average energy detected coincidentally by each of a first pair of said detectors, to define a first source plane containing said radiation source;
a means of comparing the average energy detected coincidentally by each of a second pair of said detectors, not co-linear with said first pair of detectors, to define a second source plane containing said radiation source, said radiation source being thereby localized to the line of intersection of said first and second source planes.

2. The Compton camera of claim 1 wherein said radiation detectors comprise a scintillator material and a photodetector.

3. The Compton camera of claim 2 wherein said scintillator material is selected from the group consisting of: NaI, CaF₂, BaBrI₂, BaF₂, BGO, CaF₂, CeBr₃, CLAC, CLLB, CLLC, CLYC, CsI, LaBr₃, LaCl₃, LiI, LSO, LYSO, NaI, PVT, SrI₂, YAP, YAG, ZnO, and ZnS.

4. The Compton camera of claim 1 wherein said radiation source comprises a gamma-emitting radioisotope.

5. The Compton camera of claim 1 wherein said radiation is selected from the group consisting of: gamma radiation, electrons, protons, and neutrons.

6. The Compton camera of claim 1 wherein at least one of said radiation detectors comprises a photomultiplier tube, and said detection circuit comprises a high voltage supply, preamplifier, amplifier, analog to digital convertor (ADC), and a field programmable gate array (FPGA) for timing analysis.

7. The Compton camera of claim 1 wherein all of said radiation detectors are substantially identical to one another.

8. The Compton camera of claim 1 wherein at least two of said radiation detectors are different from one another.

9. A method for locating a radiation source comprising the steps of:
configuring a Compton camera with at least three energy discriminating detectors in a substantially planar array, said detectors being sufficiently close together that incident radiation scattered from one of said detectors has a finite probability of capture by another of said detectors;
comparing the average energy detected coincidentally by each of a first pair of said detectors and calculating the bearing angle defining a first source plane containing said radiation source;
comparing the energy detected coincidentally by each of a second pair of said detectors, not co-linear with said first pair of detectors, and calculating the bearing angle defining a second source plane containing said radiation source; and,
determining the line of intersection of said first and second source planes.

10. The method of claim 9 wherein at least one of said radiation detectors comprises a photomultiplier tube, and said detection circuit comprises a high voltage supply, preamplifier, amplifier, analog to digital convertor (ADC), and a field programmable gate array (FPGA) for timing analysis.

11. The method of claim 9 wherein all of said radiation detectors are substantially identical to one another.

12. The method of claim 9 wherein at least two of said radiation detectors are different from one another.

13. A method for locating a radiation source comprising the steps of:
configuring a Compton camera with at least two energy discriminating detectors in a substantially linear array, said detectors being sufficiently close together that incident radiation scattered from one of said detectors has a finite probability of capture by another of said detectors;
comparing the average energy detected coincidentally by each of at least a pair of said detectors while holding said linear array in a first position and calculating the bearing angle defining a first source plane containing said radiation source;
rotating said linear array to a second position, coplanar with said first position;
comparing the energy detected coincidentally by each of at least a pair of said detectors while holding said linear array in said second position and calculating the bearing angle defining a second source plane containing said radiation source; and,
determining the line of intersection of said first and second source planes.

14. The method of claim 13 wherein at least one of said radiation detectors comprises a photomultiplier tube, and said detection circuit comprises a high voltage supply, preamplifier, amplifier, analog to digital convertor (ADC), and a field programmable gate array (FPGA) for timing analysis.

15. The method of claim 13 wherein all of said radiation detectors are substantially identical to one another.

16. The method of claim 13 wherein at least two of said radiation detectors are different from one another.

17. The method of claim 13 wherein said second position is orthogonal to said first position.

18. The Compton camera of claim 1 wherein said radiation detectors comprise a semiconductor material.

19. The Compton camera of claim 18 wherein said semiconductor material is selected from the group consisting of: CdTe, CdZnTe, CdSeTe, CdMnTe, GaAs, Ge, HgI₂, PbI₂, Si, TlBr, ZnO, and ZnTe.

20. The Compton camera of claim 1 wherein at least one of said radiation detectors comprises a semiconductor detector, and said detection circuit comprises a high voltage supply, preamplifier, amplifier, analog to digital convertor (ADC), and a field programmable gate array (FPGA) for timing analysis.
